(19) United States
(12) Patent Application Publication
(10) Pub. No.: US 2022/0073271 A1
(43) Pub. Date: Mar. 10, 2022

(54) FLEXIBLE BLADDER TANKS INCLUDING POLYKETONE

(71) Applicant: Raven Industries, Inc., Sioux Falls, SD (US)

(72) Inventor: Steven G. Redford, Brandon, SD (US)

(21) Appl. No.: 17/420,610

(22) PCT Filed: Jan. 11, 2019
(86) PCT No.: PCT/US2019/013252

§ 371 Date: Jul. 2, 2021

(51) Int. Cl. B65D 88/12; B32B 27/28; B32B 5/02; B32B 27/32; B32B 27/08; B32B 1/00; B32B 27/30; B32B 27/12

(52) U.S. Cl. CPC B65D 88/128; B32B 27/20; B32B 5/024; B32B 5/022; B32B 27/32; B32B 27/08; B32B 1/00; B32B 27/306; B32B 27/12; B32B 2262/101; B32B 2262/0261; B32B 2262/062; B32B 2262/08; B32B 2262/0207; B32B 2439/00; B32B 2307/732; B32B 2307/54; B32B 27/288

(57) ABSTRACT

The present disclosure provides a bladder for containing a liquid. The bladder includes a polyketone layer and a fitting in contact with the polyketone layer.

### BACKGROUND

Flexible bladder tanks can be used to contain and transport a wide variety of liquids. The materials that form the bladder can greatly affect the effectiveness of the bladder. For example, to accommodate large, and therefore heavy, quantities of a liquid the material forming the bladder must be strong. If a material is not particularly strong, the material can be made thicker, but this adds undesirable excess weight to the bladder. Some materials may be particularly permeable to oxygen, which can be detrimental to a liquid that does not react well to oxygen. To counter this, some materials may be coated with a barrier layer, but this adds complexity and expense to the assembly of the bladder. There is therefore a need to manufacture bladder tanks that are light, strong, and simple to manufacture.

### SUMMARY OF THE DISCLOSURE

The present disclosure provides a bladder for containing a liquid. The bladder includes a polyketone layer and a fitting in contact with the polyketone layer.

The present disclosure further provides a bladder tank assembly. The bladder tank assembly includes a bladder for containing a liquid. The bladder includes a polyketone layer and a fitting in contact with the polyketone layer. The bladder further includes a container. In some embodiments, the bladder can be disposed within the container.

The present disclosure further provides a method for making a bladder tank. The method includes extruding a polyketone layer the method further includes contacting a fitting into the polyketone layer.

The present disclosure further provides a method of using a bladder, for containing a liquid. The bladder includes a polyketone layer and a fitting in contact with the polyketone layer. The method includes filling the bladder with a liquid.

### BRIEF DESCRIPTION OF THE FIGURES

The drawings illustrate generally, by way of example, but not by way of limitation, various embodiments discussed in the present document.

FIG. 1 is a side view of a bladder, in accordance with various embodiments.

FIG. 2, is a sectional view of another bladder, in accordance with various embodiments.

FIG. 3 is a sectional view of another bladder, in accordance with various embodiments.

FIG. 4 is a bar graph showing the tensile strength values of Examples 1, 2, and 3 in accordance with various embodiments.

FIG. 5 is a bar graph showing the percent elongation at break values of Examples 1, 2, and 3 in accordance with various embodiments.

FIG. 6 is a bar graph showing the load to puncture the film values of Examples 1, 2, and 3 in accordance with various embodiments.

FIG. 7 is a bar graph showing the coefficient of friction values of Examples 1, 2, and 3 in accordance with various embodiments.

FIG. 8 is a bar graph showing the abrasion resistance of the film values of Examples 1, 2, and 3 in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aralkyloxy group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, or cycloalkylalkyl. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, and the like; and R₃N wherein each R is independently selected, such as trialkylamines, dialkylarylamines, alkyldiarylamines, triarylamines, and the like. The term “amine” also includes ammonium ions as used herein.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

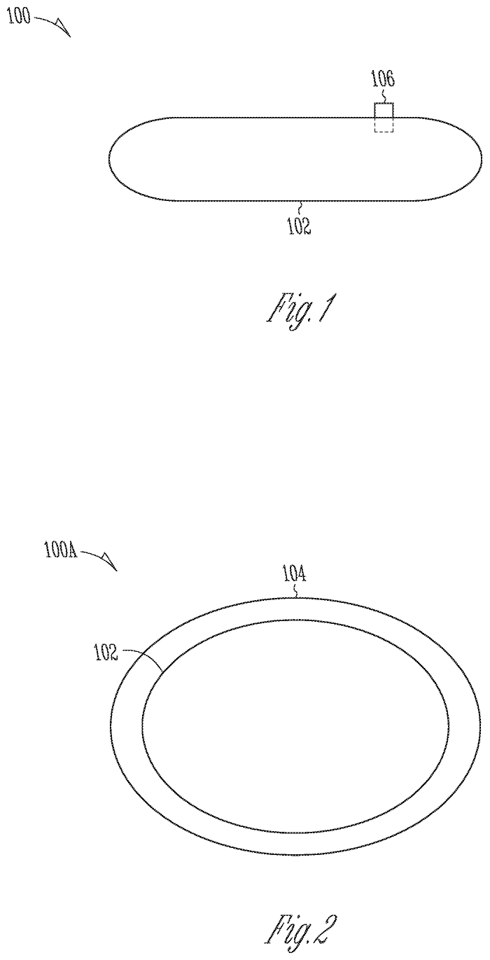

Various embodiments of the present invention are directed towards a bladder for storing a liquid. The bladders described herein generally include a layer that includes polyketone and at least one fitting in contact with the polyketone layer. The fitting can be contacted with the polyketone layer by being fully embedded therein, partially embedded therein, fully passing through the polyketone layer, partially passing through the polyketone layer, disposed on an external surface, or the like. FIG. 1 is a side view of bladder 100. As shown, bladder 100 includes polyketone layer 102 and fitting 106 in contact with layer 102. As shown, bladder 100 is a continuous structure. Bladder 100 can be welded together at opposed first and second ends. Bladder 100 can be designed to accommodate almost any suitable volume of a liquid. For example, bladder 100 can be designed to have a volume in a range of from about 15 liters to about 20,000 liters, about 1,700 liters to about 4,000 liters, less than, equal to, or greater than about 15 liters; 50; 100; 200; 300; 400; 500; 1,000; 1,500; 2,000; 2,500; 3,000; 3,500; 4,000; 4,500; 5,000; 5,500; 6,000; 6,500; 7,000; 7,500; 8,000; 8,500; 9,000; 9,500; 10,000; 10,500; 11,000; 11,500; 12,000; 12,500; 13,000; 13,500; 14,000; 14,500; 15,000; 15,500; 16,000; 16,500; 17,000; 17,500; 18,000; 18,500; 19,000; 19,500; or about 20,000 liters. Remarkably, these volumes of liquid can be accommodated by embodiments of bladder 100 in which a thickness of polyketone layer 102 is in a range of from about 0.01 mm to about 4 mm, about 0.05 mm to about 3 mm, about 0.01 mm, 0.20, 0.30, 0.40, 0.50, 0.60, 0.70, 0.80, 0.90, 1, 1.5, 2, 2.5, 3, 3.5, 4 or about 4 mm.

Polyketone layer 102 includes a polyketone. The polyketone can be in a range of from about 20 wt % to about 100 wt % of polyketone, layer 102, about 90 wt % to about 100 wt %, or less than, equal to, or greater than about 20 wt %, 25, 30, 35, 40, 45, 50, 55, 60, 65, 70, 75, 80, 85, 90, 95, or about 100 wt %. The polyketone can be any suitable polyketone. An example of a suitable polyketone can include a polyketone including a repeating unit having the structure according to Formula I:

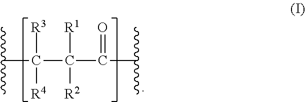

In Formula I, R¹, R², R³ and R⁴ can be independently chosen from —H, —OH, substituted or unsubstituted (C₁-C₂₀) hydrocarbyl. In further examples the (C₁-C₂₀)hydrocarbyl is chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, and (C₁-C₂₀)alkoxy, combinations thereof.

In additional embodiments, the polyketone can be a copolymer that includes repeating units having the structures according to Formula II or Formula III:

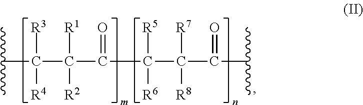

In Formula II, R¹, R², R³, R⁴, R⁵, R⁶, R⁷, and R⁸ can be independently chosen from —H, —OH, substituted or unsubstituted (C₁-C₂₀)hydrocarbyl. In further embodiments, the (C₁-C₂₀)hydrocarbyl can be chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, and (C₁-C₂₀)alkoxy, combinations thereof. In further embodiments R¹⁰ can be —CH₃. In further embodiments, R¹, R², R³, R⁴, R⁵, R⁶, R⁷, and R⁸ can each be —H. In any embodiment of Formula II, a degree of polymerization of m and n are positive integers and the repeating can be in random, block, or alternating configuration.

In embodiments where the polyketone is a copolymer, the polyketone can include any suitable additional repeating units. For example, the polyketone copolymer can include a repeating unit derived from ethylene, propylene, vinyl chloride, vinylidene chloride, styrene, acrylonitrile, tetrafluoroethylene, methyl methacrylate, vinyl acetate, isoprene, chloroprene, or a mixture thereof.

Polyketone layer 102 may include one polyketone or a mixture of polyketones. If polyketone layer 102 includes a mixture of polyketones the polyketones can differ by composition (e.g., different repeating units or arrangement of repeating units). Furthermore, individual polyketone polymers can have different weight-average molecular weights. The weight-average molecular weight of any individual polyketone can be in a range of from about 5000 Daltons to about 50,000 Daltons, about 15,000 Daltons to about 25,000 Daltons, or less than, equal to, or greater than about 5,000 Daltons, 10,000, 15,000, 20,000, 25,000, 30,000, 35,000, 40,000, 45,000, or about 50,000 Daltons.

In examples where polyketone layer 102 includes less than 100 wt % polyketone, polyketone, layer 102 can include many suitable additives or components. For example, polyketone layer 102 may include other polymers such as a polyolefin or polyamide. Examples of suitable polyolefins include polypropylenes or polyethylenes (e.g., low-density polyethylene or a high density polyethylene). If polyketone layer 102 does include a blend of polyketone and another polymer component, the polyketone can be in a range of from about 20 wt % to about 99 wt % of polyketone layer 102 about 50 wt % to about 80 wt %, less than, equal to, or greater than about 20 wt %, 25, 30, 35, 40, 45, 50, 55, 60, 65, 70, 75, 80, 85, 90, 95, or about 99 wt %.

In further embodiments, polyketone layer 102 can include a colorant. The colorant can be chosen from many suitable pigments such as titanium oxide or carbon black. Where present, the colorant can be in any concentration by wt % of polyketone layer 102. For example, the colorant can be present from about 0.001 wt % to about 8 wt % of polyketone layer 102, about 0.01 wt % to about 3 wt %, or less than, equal to, or greater than about 0.001 wt %, 0.01, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, or about 8 wt %.

Polyketones are inherently heat resistant in that they can resist degradation upon exposure to high levels of heat. Therefore, including a polyketone in polyketone layer 102 can provide suitable heat resistance to bladder 100. For example, polyketone layer 102 can impart a heat resistance to a temperature of at least 100° C., at least 150° C., in a range of about 50° C. to about 200° C., about 100° C. to about 150° C., less than about 50° C., 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200° C. In some embodiments, the heat resistant properties of polyketone layer 102, and therefore bladder 100 can be increased by including a flame retardant therein. The flame retardant additive can enhance the inherent heat resistivity and flame retardant characteristics of the polyketone described herein. The flame retardant additive can account for any wt % of polyketone layer 102. For example, the flame retardant can range from about 0.4 wt % to about 20 wt % of polyketone layer 102, from about 4 wt % to about 15 wt %, or less than, equal to, or greater than about 0.4 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %.

Examples of suitable flame retardants include, for example, organophosphorous compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants.

Polyketone layer 102 can further include stabilizers that stabilize the polyketone against damage caused by exposure to ultra violet radiation. This can help to improve the longevity of bladder 100 by helping to prevent breakdown of polyketone layer 102 upon exposure to ultra violet radiation. Where present, these stabilizers can account for any wt % of polyketone layer 102. For example, the stabilizer can range from about 0.5 wt % to about 20 wt % of the polyketone layer, about 5 wt % to about 10 wt %, or less than, equal to, or greater than about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %. Examples of suitable stabilizers can include a stabilizer chosen from an antioxidant, a hindered amine light stabilizer, an ultraviolet absorber, an antioxidant, an organosulfur compound, or a mixture thereof.

Polyketone layer 102 can further include a filler. The filler can be helpful to reduce the amount of polyketone that is use in bladder 100, this can reduce the costs associated with making bladder 100. Where present, the filler can account for any portion of polyketone layer 102. For example, the filler can range from about 1 wt % to about 60 wt % of polyketone layer 102, about 10 wt % to about 30 wt %, or less than, equal to, or greater than about 1 wt %, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56 57, 58, 59, or about 60 wt %.

In some embodiments, polyketone layer 102 can include a woven or non-woven material fully embedded therein. For example, the woven or non-woven can include any suitable reinforcing material. For example, the reinforcing material can include a woven material, a non-woven material, or a mixture thereof. Examples of woven or non-woven materials can include fiber glass, nylon, cotton, cellulosic fiber, wool, rubber, or mixtures thereof.

In some embodiments, polyketone layer 102 can include additional polymers such as a polyethylene, a polypropylene, or a mixture thereof. Where present, the polyethylene, the polypropylene, or the mixture thereof can be in a range of from about 5 wt % to about 80 wt %, of polyketone layer 102, about 20 wt % to about 50 wt %, less than, equal to, or greater than about 5 wt %, 10, 15, 20, 25, 30, 35, 40, 45, 50, 55, 60, 65, 70, 75, or about 80 wt %. In further embodiments, polyketone layer 102 can be substantially free of a polyethylene, a polypropylene, or a mixture thereof. The ability to not include a polyethylene, a polypropylene, or a mixture thereof differentiates bladder 100 from convention bladders that cannot hold a comparable volume of a liquid while having a thin construction. Nor can conventional bladders that are free of polyketone hold liquid that would react with a polyethylene, a polypropylene, or a mixture thereof and thereby degrade the bladder 100. Polyketone layer 102 can further be free of an ethylene vinyl alcohol copolymer.

As shown in FIG. 1, bladder 100 includes fitting 106 in contact with polyketone layer 102. Bladder 100 can include one or more fittings 106, which can be any component of bladder 100. For example, fitting 106 can be an opening, a fill port, a discharge port, a vent port, or a combination thereof. Fitting 106 can be made from a metal or a polymeric material. In some embodiments, fitting 106 can have substantially the same composition as any one of polyketone layer 102.

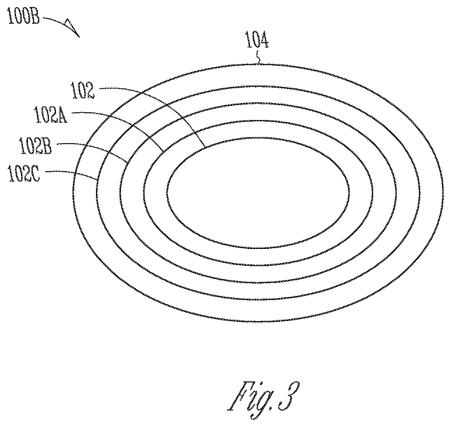

In various embodiments of the present disclosure, bladder 100 can include multiple coextruded layers or materials. For example, FIG. 2, is a sectional view of bladder 100A, which has a multi-layer structure. As shown, bladder 100A includes polyketone layer 102 having polyolefin layer 104 attached thereto. Polyolefin layer 104 can include a polyethylene, a polypropylene, copolymers thereof, or mixtures thereof. Layers 102 and 104 are shown as separated from each other, but in operation layers 102 and 104 are joined by extrusion or through a tie layer.

If present, the tie layer can include a tie resin to help hold the multi-layered structure together. A tie resin, or compatibilization agent, can increase compatibility between two or more polymers. For example, a compatibilization agent can be a tie layer between layers that can increase the bonding strength between the layers, or can be an agent added to the layer to increase miscibility of the other components of the layer. A compatibilization agent can be passive (e.g., does not react with other components of the layers) or reactive (e.g., reacts with other components of the layers, such as to form crosslinks or grafting). Examples of compatibilization agents can include silane coupling agents, titanate coupling agents, silane adhesion promoters, phenolic adhesion promotors, titanate adhesion promotors, zirconate adhesion promotors, modified polyolefins (e.g., modified to include one or more polar groups, such as a copolymer including polyethylene repeating units and polyolefin repeating units including one or more polar functional groups, such as a copolymer including polyethylene and repeating units formed from maleic anhydride or maleic acid, such as Bynel® 4157, or a polyethylene-co-vinyl acetate such as Polysciences Cat. No. 25359-25), styrene-based polymers (e.g., a polymer including styrene and butadiene repeating units, such as Krayton® D1102), methacrylate-based polymers, polycaprolactone-based polymers, polycaprolactone polyester/poly(tetramethylene glycol) copolymers, methacrylate-terminated polystyrene, mixture of aliphatic resins of low of medium molecular weight, and tri-block copolymers.

In some embodiments, polyolefin layer 104 can be substituted with a reinforcing layer. The reinforcing layer can be attached to an external surface of polyketone layer 102. Alternatively, the reinforcing layer can be fully or partially embedded into polyketone layer 102. The reinforcing layer, however is not positioned to define an interior of bladder 100A, such that it is in direct contact with the liquid that bladder 100A contains. Where present, the reinforcing layer can include fiber glass, nylon, cotton, cellulosic fiber, wool, rubber, or a mixture thereof.

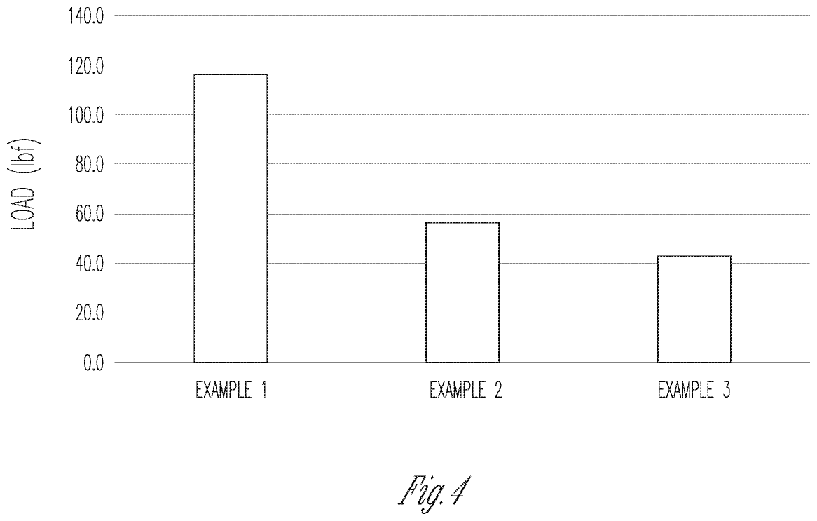

In some embodiments a bladder can include several layers comprising the same material for example, as shown in FIG. 3, bladder 100B includes polyketone layers 102, 102A, 102B, and 102C. Each of polyketone layers 102, 102A, 102B, and 102C includes the same materials or mixture of materials. Polyketone layers 102, 102A, 102B, and 102C can be coextruded as a multi-layer structure. Polyolefin 104 or a reinforcing layer can be attached to polyketone layer 102C.

Any of bladders 100, 100A, or 100B can be placed within a container. Placing any of bladders 100, 100A, or 100B in a container can be useful if any of bladders 100, 100A, or 100B are shipped. Examples of suitable containers can include a metal container, a plastic container, or a container being a composite of a metal and a plastic.

Bladder 100 can be manufactured according to any suitable method. For example, polyketone layer 102 can be extruded as a sheet. Any additives such as flame retardants, stabilizers, fillers, or the like can be mixed into the polyketone starting material prior to extrusion. In some embodiments, polyketone is provided as a pellet that can be 100 wt % polyketone or include a blend of materials.

Following extrusion, ends of the polyketone layer 102 are welded together to form a sealed structure that is capable of containing a liquid. Fitting 106 is can be in contact with polyketone layer 102 and a junction between fitting 106 and polyketone layer is sealed.

In operation, bladder 100 is designed to contain a liquid. Bladder 100 is capable of expansion to accommodate potentially large volumes of a liquid. By virtue of bladder 100 including polyketone, bladder is capable of holding a large quantity of a liquid without failing. Additionally, polyketone has a relatively low permeability to oxygen. Therefore liquids contained therein can be shielded from exposure to oxygen. This can be useful for example in shipping wine. Advantageously, low permeability to oxygen can be accomplished using polyketone, which can obviate the use of an ethylene vinyl alcohol copolymer coating. Additionally, polyketone has good resistance to volatile or potentially corrosive chemicals. This can allow bladder 100 to be used to contain a substituted or unsubstituted (C₁-C₅₀)hydrocarbyl liquids or a substituted or unsubstituted (C₁-C₅₀)aryl liquids. Bladder can also be used to contain an acidic solution having a pH in a range of from about 0 to about 4 or a basic solution having a pH in a range of from about 10 to about 14. Bladder 100 can also be used to contain neutral liquids such as water.

### EXAMPLES

Various embodiments of the present disclosure can be better understood by reference to the following Examples which are offered by way of illustration. The present disclosure is not limited to the Examples given herein.

Three film samples where manufactured each having a thickness of 0.250 mm. Example 1 included a polyketone. Example 2 included polyethylen. Example 3 included polyethylene and an EVOH barrier. Examples 1, 2, and 3 were evaluated for their tensile strength, percent elongation at break, load required to puncture, coefficient of friction, and abrasion resistance.

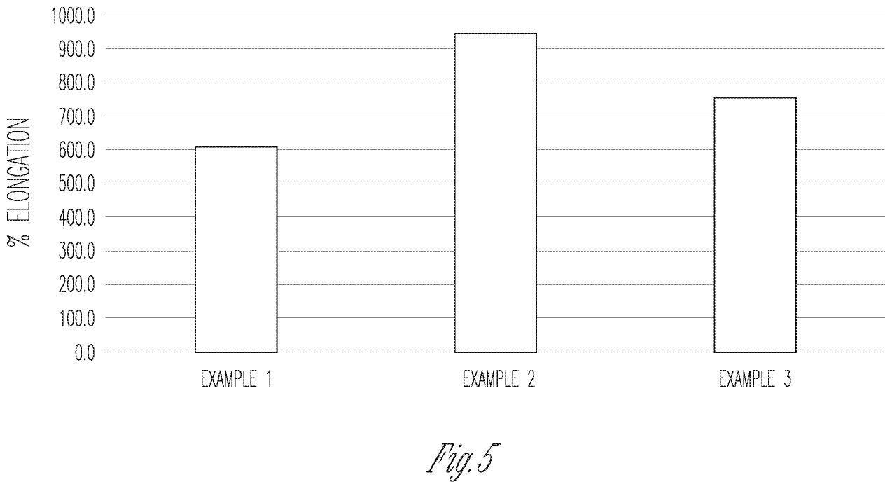

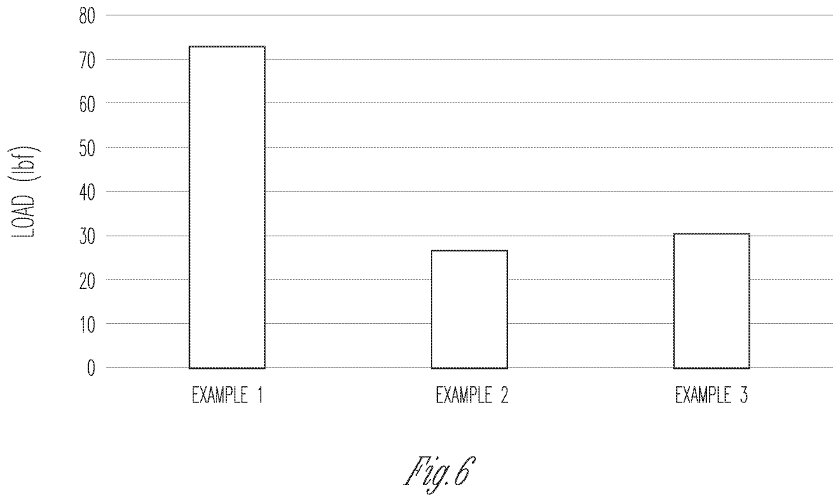

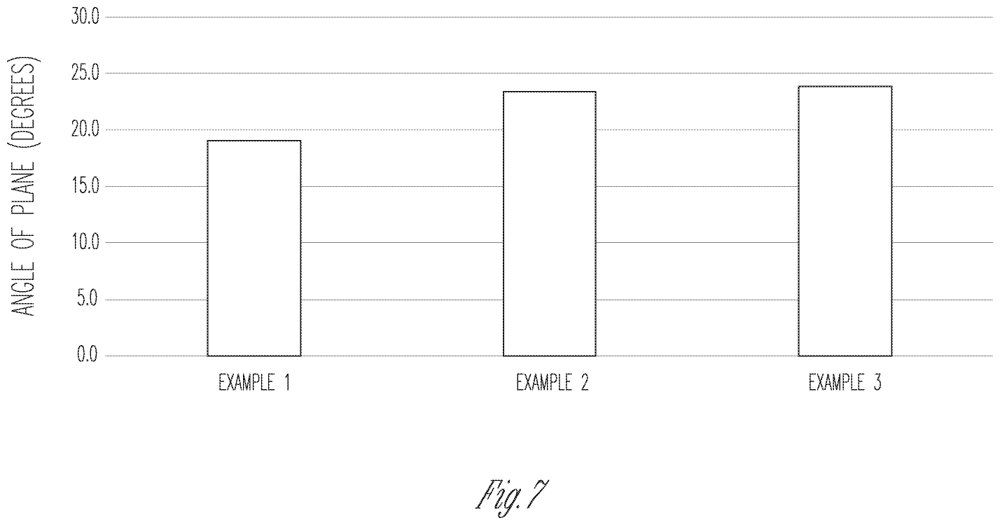

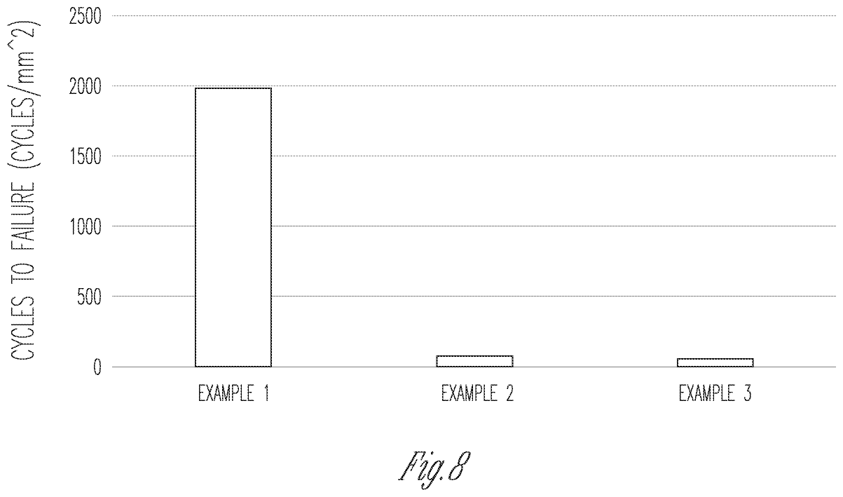

The tensile strength of Examples 1, 2, and 3 were measured according to ASTM D882 (2016). As shown in FIG. 4, Example 1 exhibited the largest tensile strength. The percent elongation at break was measured according to ASTM D882 (2016). As shown in FIG. 5, Example 1 was able to achieve greater than 600% elongation at break. The load required to puncture Examples 1, 2, and 3 was measured according to ASTM D4833 (2008). As shown in FIG. 6, Example 1 required the largest load to puncture the film. The coefficient of friction of each of Examples 1, 2, and 3 was measured according to Tappi method T-815. As shown in FIG. 7, Example 1 had the lowest coefficient of friction. The abrasion resistance of Examples 1, 2, and 3 was measured by contacting each of Examples 1, 2, and 3 with a woven PP material and moving woven PP material 12 inches in a cyclic manner with a frequency of 45 cycles per minute and a contact force of 2.7 Newtons. As shown Example 1 sustained the most abrasion cycles of 8000 with no noticeable degradation. At this point the test was halted.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments.

The following exemplary embodiments are provided, the numbering of which is not to be construed as designating levels of importance:

Embodiment 1 provides a bladder for containing a liquid, the bladder comprising:

a polyketone layer; and

a fitting in contact with the polyketone layer.

Embodiment 2 provides the bladder of Embodiment 1, wherein the polyketone layer comprises a polyketone in a range of from about 2.5 wt % to about 100 wt % of the polyketone layer.

Embodiment 3 provides the bladder of Embodiment 2, wherein polyketone comprises an aliphatic polyketone, an aromatic polyketone, or mixtures thereof.

Embodiment 4 provides the bladder of anyone of Embodiments 2 or 3, wherein the polyketone comprises a repeating unit having the structure according to Formula I:

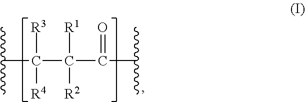

wherein R¹, R², R³ and R⁴ are independently chosen from —H, —OH, and substituted or unsubstituted (C₁-C₂₀) hydrocarbyl.

Embodiment 5 provides the bladder of Embodiment 4, wherein the (C₁-C₂₀)hydrocarbyl is chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, (C₁-C₂₀)alkoxy, and combinations thereof.

Embodiment 6 provides the bladder of any one of Embodiments 4 or 5, wherein the polyketone comprises repeating units according to Formula II:

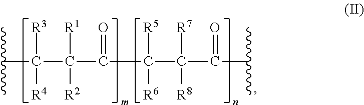

wherein

R¹, R², R³, R⁴, R⁵, R⁶, R⁷, and R⁸ are independently chosen from —H, —OH, and substituted or unsubstituted (C₁-C₂₀)hydrocarbyl,

wherein m and n are positive integers and represent a degree of polymerization, and

the repeating units shown in Formula II are in random, block, or alternating configuration.

Embodiment 7 provides the bladder of Embodiment 6, wherein the (C₁-C₂₀)hydrocarbyl is chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, (C₁-C₂₀)alkoxy, and combinations thereof.

Embodiment 8 provides the bladder of any one of Embodiments 6 or 7, wherein R⁸ is —CH₃.

Embodiment 9 provides the bladder of any one of Embodiments 6-8, wherein R¹, R², R³, R⁴, R⁵, R⁶, and R⁷ are each —H.

Embodiment 10 provides the bladder of any one of Embodiments 2-9, wherein the polyketone is a copolymer and further comprises a repeating unit derived from ethylene, propylene, vinyl chloride, vinylidene chloride, styrene, acrylonitrile, tetrafluoroethylene, methyl methacrylate, vinyl acetate, isoprene, chloroprene, or a mixture thereof.

Embodiment 11 provides the bladder of any one of Embodiments 2-10, wherein the polyketone layer comprises a plurality of polyketone polymers having different weight-average molecular weights.

Embodiment 12 provides the bladder of any one of Embodiments 2-11, wherein the polyketone layer further comprises a colorant.

Embodiment 13 provides the bladder of Embodiment 12, wherein the colorant is in a range of from about 0.001 wt % to about 8 wt % of the polyketone layer.

Embodiment 14 provides the bladder of any one of Embodiments 12 or 13, wherein the colorant is in a range of from about 0.01 wt % to about 3 wt % of the polyketone layer.

Embodiment 15 provides the bladder of any one of Embodiments 1-14, wherein the polyketone layer further comprises a flame retardant.

Embodiment 16 provides the bladder of Embodiment 15, wherein the flame retardant is in a range of from about 0.4 wt % to about 20 wt % of the polyketone layer.

Embodiment 17 provides the bladder of any one of Embodiments 15 or 16, wherein the flame retardant is in a range of from about 4 wt % to about 15 wt % of the polyketone layer.

Embodiment 18 provides the bladder of any one of Embodiments 15-17, wherein the flame retardant is chosen from a phosphorous-containing flame retardant additive, a halogen-containing flame retardant, a metal-hydroxide-containing flame retardant, and a mixture thereof.

Embodiment 19 provides the bladder of any one of Embodiments 1-18, wherein the polyketone layer further comprises a stabilizer chosen from an antioxidant, a hindered amine light stabilizer, an ultraviolet absorber, an antioxidant, an organosulfur compound, or a mixture thereof.

Embodiment 20 provides the bladder of Embodiment 19, wherein the stabilizer ranges from about 0.5 wt % to about 20 wt % of the polyketone layer.

Embodiment 21 provides the bladder of any one of Embodiments 19 or 20, wherein the stabilizer ranges from about 5 wt % to about 10 wt % of the polyketone layer.

Embodiment 22 provides the bladder of any one of Embodiments 1-21, wherein a thickness of the polyketone layer is in a range of from about 0.01 mm to about 4 mm.

Embodiment 23 provides the bladder of any one of Embodiments 1-22, wherein a thickness of the polyketone layer is in a range of from about 0.025 mm to about 3 mm.

Embodiment 24 provides the bladder of any one of Embodiments 1-23, wherein a thickness of the polyketone layer is in a range of from about 5 percent to about 100 percent of the total thickness of the bladder.

Embodiment 25 provides the bladder of any one of Embodiments 1-24, wherein a thickness of the polyketone layer is in a range of from about 30 percent to about 50 percent of the total thickness of the bladder.

Embodiment 26 provides the bladder of any one of Embodiments 1-25, wherein the polyketone layer is substantially free of at least one of a polyethylene, a polypropylene, and a mixture thereof.

Embodiment 27 provides the bladder of any one of Embodiments 1-25, wherein the polyketone layer comprises at least one of a polyethylene, a polypropylene or a mixture thereof in a range of from about 5 wt % to about 80 wt %.

Embodiment 28 provides the bladder of any one of Embodiments 1-27, wherein the polyketone layer is free of an ethylene vinyl alcohol copolymer in a range of from about 5 wt % to about 80 wt %.

Embodiment 29 provides the bladder of any one of Embodiments 1-27, wherein the polyketone layer comprises an ethylene vinyl alcohol copolymer in a range of from about 5 wt % to about 80 wt %.

Embodiment 30 provides the bladder of any one of Embodiments 1-29, wherein the polyketone layer further comprises a filler.

Embodiment 31 provides the bladder of Embodiment 30, wherein the filler is in a range of from about 1 wt % to about 60 wt % of the polyketone layer.

Embodiment 32 provides the bladder of any one of Embodiments 30 or 31, wherein the filler comprises calcium carbonate, talc, carbon black, or mixtures thereof.

Embodiment 33 provides the bladder of any one of Embodiments 1-32, wherein the polyketone layer comprises a multi-layer structure.

Embodiment 34 provides the bladder of Embodiment 33, wherein each layer of the multi-layer structure comprises a polyketone.

Embodiment 35 provides the bladder of any one of Embodiments 1-34, further comprising a reinforcing layer adjacent to the polyketone layer.

Embodiment 36 provides the bladder of Embodiment 35, wherein the reinforcing layer is in contact with the polyketone layer.

Embodiment 37 provides the bladder of any one of Embodiments 35 or 36, wherein the reinforcing layer comprises a woven or non-woven material comprises fiber glass, nylon, cotton, cellulosic fiber, wool, rubber, or a mixture thereof.

Embodiment 38 provides the bladder of any one of Embodiments 1-37, further comprising a polyolefin layer adjacent to the polyketone layer.

Embodiment 39 provides the bladder of Embodiment 38, wherein the polyolefin layer is in contact with the polyketone layer.

Embodiment 40 provides the bladder of any one of Embodiments 38 or 39, wherein the polyolefin layer comprises a polyethylene, a polypropylene, copolymers thereof, or mixtures thereof.

Embodiment 41 provides the bladder of any one of Embodiments 1-40, wherein the fitting has substantially the same composition as of the polyketone layer.

Embodiment 42 provides the bladder of any one of Embodiments 1-41 wherein the fitting comprises an opening, a fill port, a discharge port, a vent port, or a combination thereof.

Embodiment 43 provides the bladder of any one of Embodiments 1-42, wherein the bladder is substantially free of ethylene vinyl alcohol copolymer.

Embodiment 44 provides the bladder of any one of Embodiments 1-43, wherein the bladder has a volume in a range of from about 15 liters to about 20,000 liters.

Embodiment 45 provides the bladder of any one of Embodiments 1-44, wherein the bladder has a volume in a range of from about 1,700 liters to about 4,000 liters.

Embodiment 46 provides the bladder of any one of Embodiments 1-45, wherein the polyketone layer is heat resistant to a temperature of at least 100° C.

Embodiment 47 provides the bladder of any one of Embodiments 1-46, wherein the polyketone layer is heat resistant to a temperature of at least 150° C.

Embodiment 48 provides the bladder of any one of Embodiments 1-47, wherein the polyketone layer is heat resistant to a temperature in a range of from about 50° C. to about 200° C.

Embodiment 49 provides the bladder of any one of Embodiments 1-48, wherein the polyketone layer is heat resistant to a temperature in a range of from about 100° C. to about 150° C.

Embodiment 50 provides the bladder of any one of Embodiments 1-49, wherein a thickness of the polyketone layer is in a range of from about 0.01 mm to about 4 mm.

Embodiment 51 provides the bladder of any one of Embodiments 1-50, wherein a thickness of the polyketone layer is in a range of from about 0.05 mm to about 3 mm.

Embodiment 52 provides the bladder of any one of Embodiments 1-51, wherein the polyketone layer is weldable.

Embodiment 53 provides the bladder of any one of Embodiments 1-52, further comprising a weld formed between a first end and a second end of the polyketone layer.

Embodiment 54 provides a bladder tank assembly comprising:

the bladder of any one of Embodiments 1-53; and

a container, wherein the bladder is disposed within the container.

Embodiment 55 provides the bladder tank assembly of Embodiment 54, wherein the container is a metal container, a plastic container, or a combination thereof.

Embodiment 56 provides a method for making the bladder tank of any one of Embodiments 1-55, the method comprising:

extruding the polyketone layer; and

contacting the fitting with the polyketone layer.

Embodiment 57 provides the method of Embodiment 56, wherein the polyketone layer is a multi-layer structure.

Embodiment 58 provides a method of using the bladder of any one of Embodiments 1-57, the method comprising filling the bladder with a liquid.

Embodiment 59 provides the method of Embodiment 58, wherein the liquid comprises a substance comprising water, a substituted or unsubstituted (C₁-C₅₀)hydrocarbyl, a solution having a pH in a range of from about 0 to about 4, a solution having a pH in a range of from about 10 to about 14, or a mixture thereof.

Embodiment 60 provides the method of Embodiment 59, wherein the substituted or unsubstituted (C₁-C₅₀)hydrocarbyl comprises a (C₁-C₅₀)aryl.

1. A bladder for containing a liquid, the bladder comprising:
a polyketone layer; and
a fitting in contact with the bladder.

2. The bladder of claim 1, wherein the polyketone layer comprises a polyketone in a range of from about 2.5 wt % to about 100 wt % of the polyketone layer.

3. The bladder of claim 2, wherein polyketone comprises an aliphatic polyketone, an aromatic polyketone, or mixtures thereof.

4. The bladder of any one of claims 2, wherein the polyketone is a copolymer and further comprises a repeating unit derived from ethylene, propylene, vinyl chloride, vinylidene chloride, styrene, acrylonitrile, tetrafluoroethylene, methyl methacrylate, vinyl acetate, isoprene, chloroprene, or a mixture thereof.

5. The bladder of any one of claims 1, wherein the polyketone layer comprises a multi-layer structure.

6. The bladder of claim 5, wherein each layer of the multi-layer structure comprises a polyketone.

7. The bladder of any one of claims 1, further comprising a reinforcing layer adjacent to the polyketone layer.

8. The bladder of claim 7, wherein the reinforcing layer comprises a woven or non-woven material comprises fiber glass, nylon, cotton, cellulosic fiber, wool, rubber, or a mixture thereof.

9. The bladder of any one of claims 1, further comprising a polyolefin layer adjacent to the polyketone layer.

10. The bladder of any one of claims 1, wherein the fitting has substantially the same composition as of the polyketone layer.

11. The bladder of any one of claims 1, wherein the bladder is substantially free of ethylene vinyl alcohol copolymer.

12. A bladder tank assembly comprising:
the bladder of any one of claims 1; and
a container, wherein the bladder is disposed within the container.

13. The bladder tank assembly of claim 12, wherein the container is a metal container, a plastic container, or a combination thereof.

14. A method for making the bladder tank of any one of claims 1, the method comprising:
extruding the polyketone layer; and
connecting the fitting into the polyketone layer.

15. The method of claim 14, wherein the polyketone layer is a multi-layer structure.
